(19) United States
(12) Patent Application Publication
(10) Pub. No.: US 2006/0144424 A1
(43) Pub. Date: Jul. 6, 2006

(54) Washing machine with a dispenser for a diversified dispensing of washing agents, and a device and method for implementation thereof

(75) Inventors: Giuseppe Marchitto, Pinerolo (IT); Nicola Gaudiano, Torino (IT); Michele Farano, Torino (IT)

Correspondence Address: LEVINE & MANDELBAUM, 444 MADISON AVENUE, 35TH FLOOR, NEW YORK, NY, 10022, US

(73) Assignee: INDESIT COMPANY S.P.A., FABRIANO (IT)

(21) Appl. No.: 10/548,713

(22) PCT Filed: Mar. 24, 2004
(86) PCT No.: PCT/IB04/00877

§ 371 Date: Feb. 17, 2006

(30) Foreign Application Priority Data
Mar. 24, 2003 (IT) TO2003A000214

(51) Int. Cl. B08B 7/04; B08B 9/20; B08B 3/00; B08B 3/12

(52) U.S. Cl. 134/25.2; 134/56 D; 134/58 D; 134/184; 134/18; 134/34

(57) ABSTRACT

The present invention relates to a washing machine, in particular a dishwasher, having a washing agents dispenser with an actuator for dispensing washing agents inside a wash tub of the washing machine, and a wash pump for wash water circulation inside a hydraulic circuit of the machine. The actuator is assembled in a direct fluid connection to the wash pump so that dispensing of the washing agents of the dispenser is driven by the wash pump through the change of the delivery pressure generated by its operation. The present invention provides a saving of the inner resources of the washing machine, which no longer requires an actuator for the sole purpose of dispensing the washing agents in the tub.

The present invention relates to a washing machine, in particular a dishwasher comprising a washing agents dispenser with an improved operation, of a type which can be defined as a dispenser with a “diversified dispensing operation”, as well as to a device and/or a method for implementing a dispensing of the washing agents. The dispenser subject of the present invention, can be efficiently applied to a household dishwasher either built-in in the inner door or located inside the wash tub, such as on a tray for kitchenware.

In the present description, the expression “diversified dispensing operation” means the capacity of a dispenser to deliver a variable amount of washing agents in the wash tub of a dishwashing machine. Such a variable amount can be dispensed in different doses both during a complete wash cycle and during a single wash step.

Moreover, in all the present description the expression “direct fluid connection” means a fluid connection through any physical means ensuring a physical continuous flow of the fluid in said physical element, without interrupting the continuous flow of said fluid.

Washing agents dispensers assembled on washing machines, in particular on household dishwashers, should in general possibly warrant a practical utilization associated to reliability with time, no need for maintenance and low manufacturing costs. Nowadays, the research for a low-cost operation of washing machines is becoming more and more important, with a consequent production of machines using less resources for their manufacture and use. Another main factor is represented by the execution of wash cycles with a low environmental impact, i.e. less quantities of washing agents, higher quality washing agents and less electric power.

These requirements lead to structured wash cycles performing fine dosages of the washing agents to be dispensed even in one same cycle step. At the same time the trend is to explore new solutions for integrating the components inside the machine, in order to save resources and further reduce manufacturing and utilization costs.

Also the importance of some logistic factors in the manufacture of the washing machines and their relevant dispensers should be highlighted, such as the need of developing an easy loading of the washing agents in the respective dispensers, over than investigating the opportunity of maximizing the space used for containing the kitchenware to be washed.

Several dispensers of powder washing agents, as well as of liquid brigthener, directly assembled on the kitchenware tray are already known at the state of the art. An example disclosed by the application of the European Patent No. 0 755 650, filed in the name of Whirlpool Europe B.V., teaches how to manufacture a dishwasher with a washing agents and brigthener dispenser associated to a movable tray of the machine, in particular the upper tray. The actuation of dispensing the washing agents and brigthener is performed through an electromagnet-aided device, which opens special inner ducts inside the dispenser to execute washing with the water from the compartments containing the washing agents. Water is supplied to the dispenser from a duct derived from the main in fluid connection to the circuit downstream the wash pump of the machine through an interlaying solenoid valve controlling such a dispensing operation.

Other washing agents dispensers are also known, hereafter called dispensers with a “diversified dispensing operation”, usually provided to be built-in in the inner door of a dishwashing machine. These dispensers can dispense an amount of powder washing agents, which can be dosed according to multiples of a fixed volume determined by the inner geometry of the dispenser itself. Dispensing of these volumes is controlled by means of thermal actuators or other electric actuators contained in the dispenser. For this type of dispensers reference is made in particular to the Italian Patent Application TO2001A000311 filed in the name of the present Applicant, the text of which is recalled for any possible further explanations.

A first drawback of the known dispensers is represented by their capacity of dosing only multiples of predetermined amounts of washing agents, i.e. excluding the possibility of dispensing a well determinable calculated quantity, for instance depending on the wash program implemented in the machine. This provides a possible wastage of the washing agent or too small a quantity being dispensed for a proper washing of kitchenware.

Another relevant aspect is that the diversified dispensing operation dispensers known at the state of the art implement actuator devices specifically and exclusively developed for dispensing washing agents, such as thermal actuators, electric actuators or electromagnet-aided devices. This represents a drawback in view of the present rationalization, cost and resource saving techniques used for the manufacture of washing machines, in particular low-cost household dishwashers.

It should also be realized that waterproofing of the electric connections of any possible electro-actuator devices contained in the washing agents dispensers of a machine, in which water is mainly used for a great portion of its volume, always represents a delicate operation, which may often require an expensive solution, above all when such dispensers are entirely located inside the wash tub.

In this frame it is the main object of the present invention to solve the above drawbacks and provide a washing machine, in particular a dishwasher, comprising an improved washing agents dispenser with a diversified dispensing operation device. In particular, the inventive idea at the base of such manufacture provides an improved rationalization of the resources available in the washing machine implemented by such a dispenser device.

Another object is to provide with good precision a correct dosage of the washing agents to be dispensed in the wash tub of the machine, according to any possible test data gathered from the study of increasingly structured and efficient operation cycles having a low environmental impact.

A further object is to provide a convenient location of the washing agents dispenser in any area of the wash tub of the machine, including the area inside the inner door.

According to the present invention, the dispenser can be further safely and advantageously located on one of the movable trays of the dishwashing machine without generating any manufacturing and/or structural complications. So, the thickness of the inner door can be actually reduced to the advantage of a better utilization of the inner volumes of the machine.

A further object is to provide the above improvements preserving the typical features of a dispenser adapted for a household dishwasher, such as simple manufacture, easy operation, low-cost manufacture, versatility and service adaptability so as to implement a plurality of wash programs.

A further object is to provide a dispensing method, which obtains the above advantages for the machines and dispensers incorporated therein.

In order to achieve such aims, it is the object of the present invention to provide a washing agents dispenser with a diversified dispensing operation, as well as a method for implementing such a dispensing operation, including the features of the annexed claims, which form an integral part of the present description.

Further objects, features and advantages of the present invention will become apparent from the following detailed description with relevant modifications and annexed drawings, which are supplied by way of an explanatory and non limiting example, wherein:

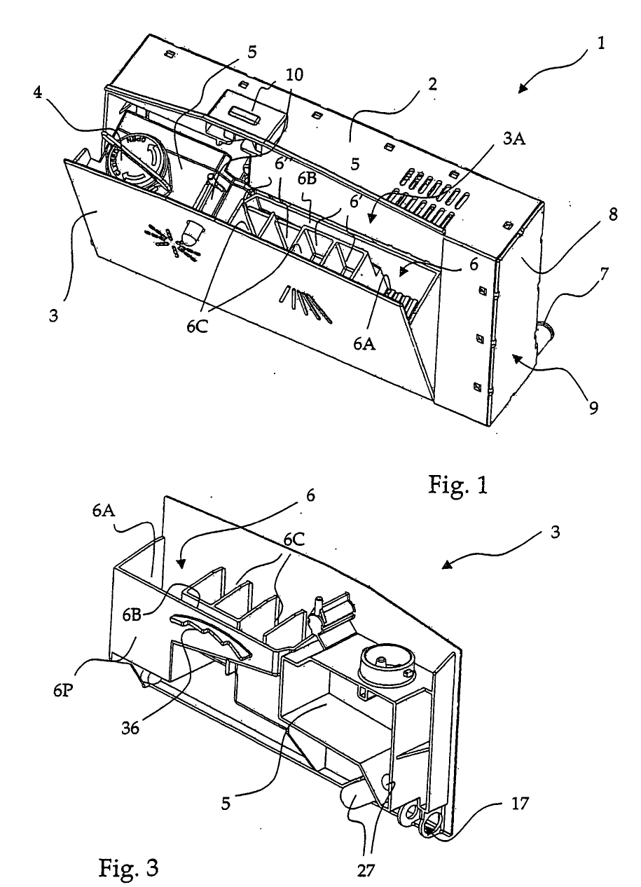

FIG. 1 shows a perspective top view of the dispenser according to the present invention, in an operating condition;

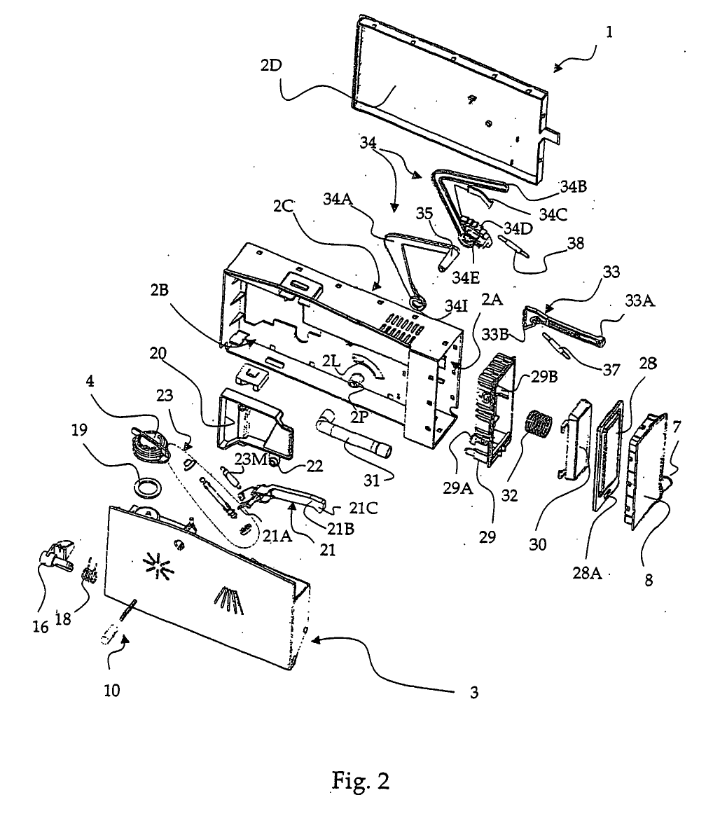

FIG. 2 shows an exploded view of the dispenser of FIG. 1;

FIG. 3 shows a perspective inside view of a detail of the dispenser of FIG. 1;

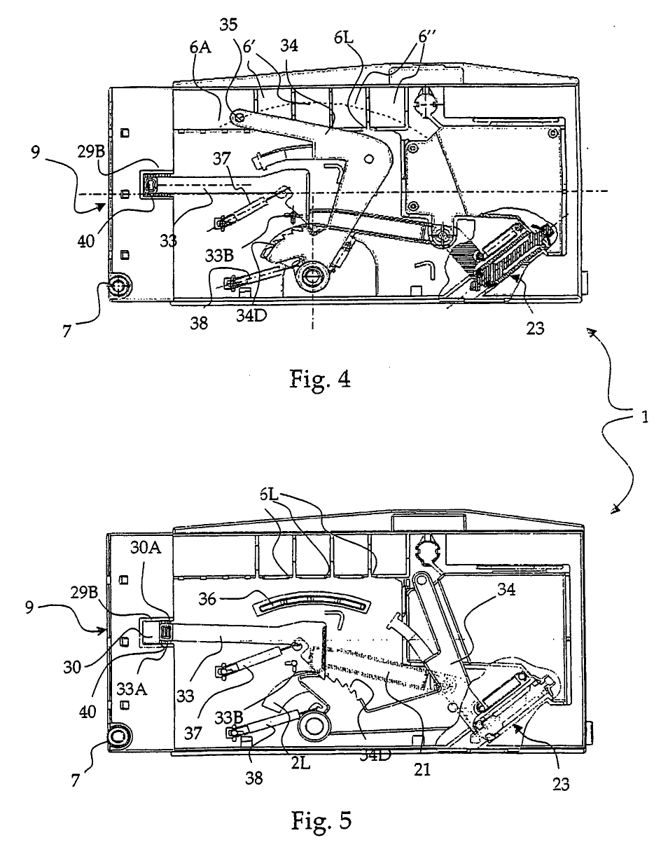

FIGS. 4 and 5 show two rear views of the dispenser of FIG. 1 deprived of some details and in two different operating conditions;

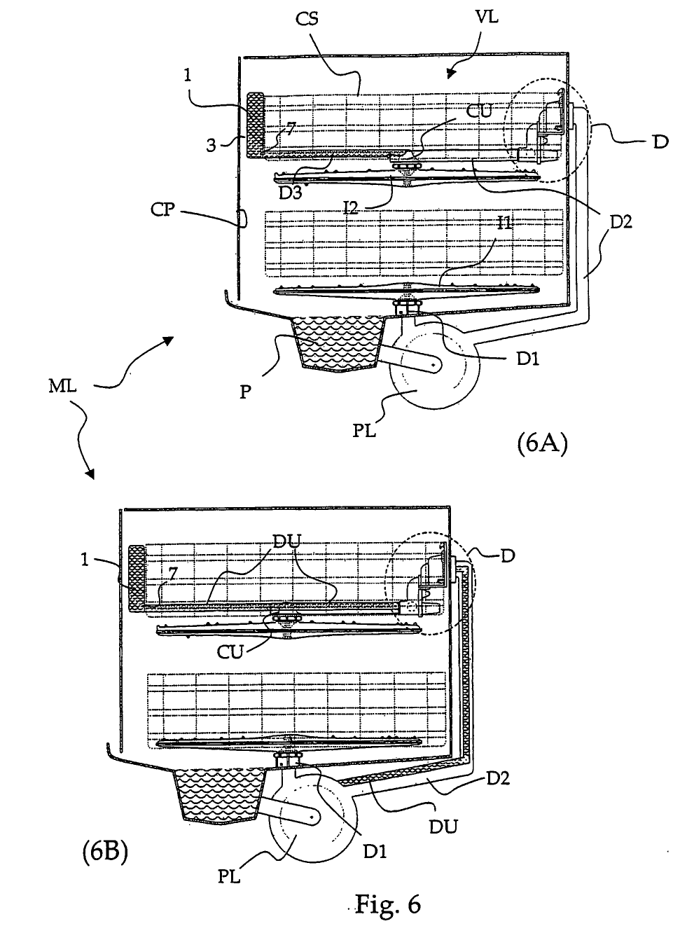

FIG. 6 shows schematically a side view of an hydraulic system 6A of a dishwashing machine incorporating the dispenser of FIG. 1 and one same view of an implementation 6B of it;

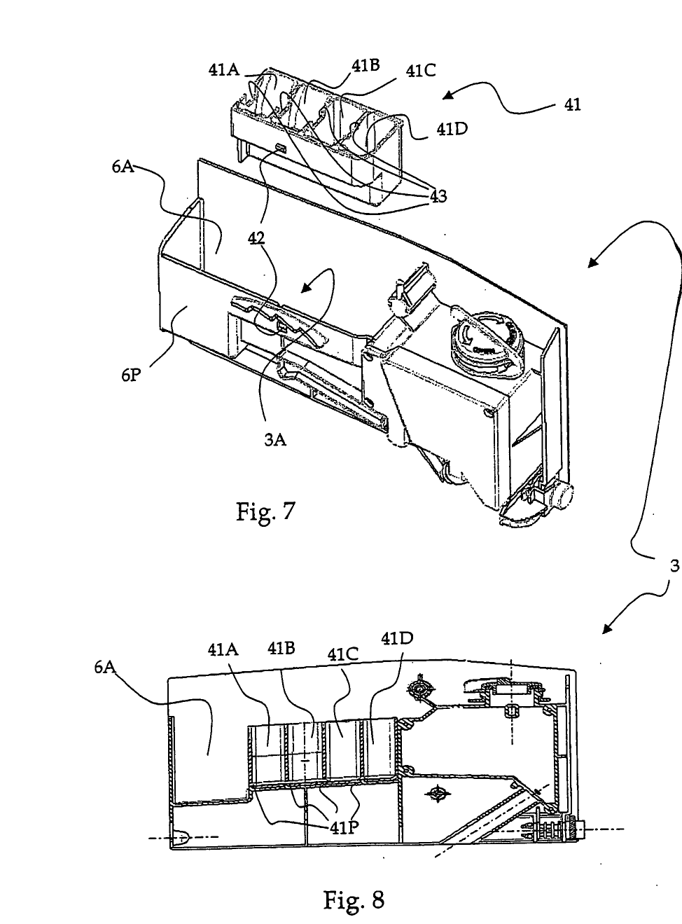

FIG. 7 shows an implementation of a detail of the view of FIG. 3;

FIG. 8 shows a lengthwise sectional view of the detail of FIG. 7;

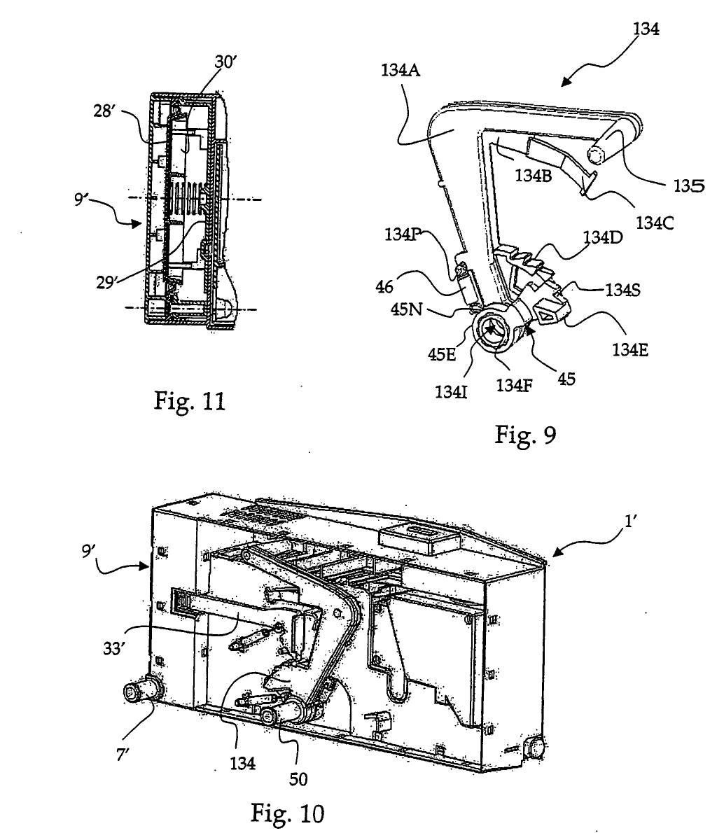

FIG. 9 shows a perspective view of an implementation of a detail of the dispenser of FIG. 1;

FIG. 10 shows a perspective rear view of an embodiment of the dispenser according to the present invention;

FIG. 11 shows a lengthwise sectional view of a portion of the dispenser of FIG. 10;

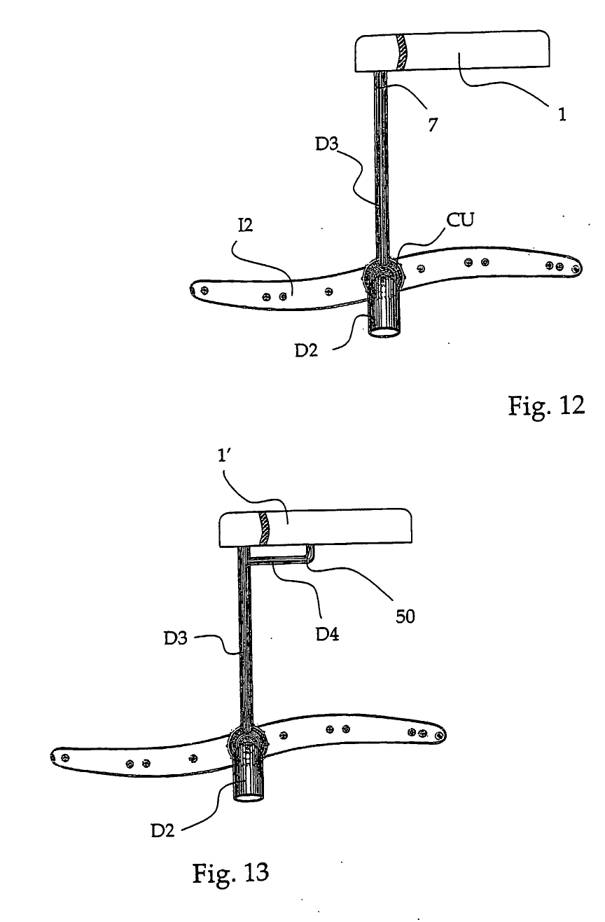

FIGS. 12 and 13 show a top view of part of the hydraulic system of a dishwashing machine incorporating the dispenser of FIG. 1 and the one of the embodiment of FIG. 10, respectively.

The figures listed above illustrate in its whole a washing agents dispenser according to the present invention with reference 1, which can be assembled both in the inner door and/or inside the tub of a dishwashing machine, in particular on a kitchenware tray.

FIG. 1 illustrates a perspective front view of the dispenser 1 consisting of a main body 2 with a tilting door 3 assembled on its front, which is adapted to operate as a movable container for housing the washing agents to be dispensed and capable of moving from a closed to an open position. Such dispenser 1 is particularly illustrated with the door 3 open; the lower section of the door 3 is hinged lengthwise to the body 2. Through this assembly the door 3 can reach an open position up to a determined acute angle for the top loading of the washing agents and be completely tilted downwards for its release from the main body 2.

FIG. 1 also shows a plug 4 for the upper closing of a tank 5 containing a liquid washing agent or brigthener, which is housed in the same door 3 next to the left side. Adjacent to the tank 5 a compartments area 3A extending lengthwise can be identified, for containing either powder or solid washing agents. In such area 3A a main container globally indicated with 6 can be detected, which comprises a hopper container 6A suitable to contain and dispense both powder and solid washing agents, and a communication section 6B. Such communication section 6B has a lengthwise extension with its bottom sloping down to the container 6A, facing on one side coplanar walls of further compartments 6C.

All the compartments 6, 6C of this embodiment are obtained as an integral body with the door 3; this notwithstanding, another embodiment can be obtained with containers 41 detachable from the door 3, as shown in the FIGS. 7 and 8. The further compartments 6C in the perspective top view of FIG. 1 are parallelepiped shaped with a substantially rectangular base and beveled edges, and they comprise:

two first compartments 6′ having their walls, facing the communication section 6B with the main compartment 6, of an equal height as that of the whole edge delimiting the compartments area 3A;

two second compartments 6″, whose walls facing the section 6B extend at a height lower than the ones related to the first compartments 6′.

All the compartments 6C have each one a bottom with a small port 6L for the outlet of the residual wash water introduced therein by the means and following procedures illustrated hereafter. The small ports 6L can be clearly seen in FIGS. 4 and 5.

According to a preferred but not exclusive form, the two first compartments 6′ are provided to contain the washing agent for performing a kitchenware pre-wash, whereas the second compartments 6″ are provided for washing kitchenware with hot water. However, this does not exclude a possible use of washing agents from more compartments for one single step, dispensing them at diversified times according to the most various wash times and methods.

The compartments area 3A with the compartments 6 and 6C can be further identified in the perspective view inside the door 3 of FIG. 3.

An inlet 7 in fluid connection to the hydraulic system of a dishwashing machine ML incorporating said dispenser 1 can also be noticed, as schematically represented in FIG. 6 and described hereafter. This inlet 7 is located behind the dispenser 1 near the bottom of the main body 2, sideways to the door 3; moreover, it is made as an integral body with a further lid 8 of a hydraulically driven actuator device, indicated as a whole with reference 9. Such actuator device 9 is housed inside a shaped seat 2A located on one end of the body 2, as clearly shown in the exploded view of FIG. 2. Finally, a quick hook/release device with a press-button, indicated globally with reference 10, is shown assembled upper to the door 3 in correspondence with an upper wall of the body 2, exactly next to the dividing plane between the compartments area 3A and the tank 5.

Such a device 10 is not further detailed, being known.

FIG. 2 highlights the particular form of the main body 2 of the dispenser 1, substantially adapted to identify three areas:
1) a shaped seat 2A sideways on one end of the body 2 itself, open to the outside and with ports inside for communication with the further areas 2B and 2C, as better detailed hereafter;
2) a front area 2B, mainly adapted to house the door 3 with its relevant elements, said door 3 determining with its own edges the same front dimensions of the whole dispenser 1;
3) a rear area 2C, divided from the front area 2B through a widely pierced shaped upright wall provided with communication ports, said rear area 2C being closed outside by a second cover 2D.

FIG. 2 is still representing, in association to the door 3:

a release control for the door 3, consisting of a movable rotating release button 16 with an interlaying torsion spring 18, inside a circular dual ring guide 17 of the door 3, clearly illustrated in FIG. 3. This control can be actuated on a projecting portion of the release button 16, that is accessible from outside;
the mentioned plug 4, provided with a gasket 19, adapted to be assembled up and down for sealing or gaining access to the brigthener tank 5;
a lid 20 of the tank 5, located on the rear to define such the tank 5 shape after its closure, providing at the an overhanging eyelet 22 on its lower side adapted to hinge a dosing control lever 21 on one side;
the above dosing control lever 21, in rotating connection to an inner part of the door 3 on the opposite side of the lid 20, so as to rotate orthogonal to the door 3 pulled back by a first return spring 23M associated to a first end 21A of the lever 21;
a liquid washing agents or brigthener dispenser device, indicated globally with 23, operating inside an appropriate traverse seat 27 below the tank 5, clearly illustrated in FIG. 3.

The brigthener dispenser device 23 with a so-called “normally open” or “normally closed” valve known in the art is not detailed for simplicity's sake. Dispensing of the brigthener is driven in a known manner through the rotation of the dosing control lever 21, namely by the first end 21A of the lever 21 itself.

The dosing control lever 21 provides a smoothed beak shaped second end 21B, which ends with an inclined plane 21C.

A membrane support 29, shaped as a cup and provided in its lower section with a passage 29A in fluid connection to a L shaped connector 31, engages inside the shaped seat 2A of the main body 2 of the dispenser 1. The connector 31 is going to squarely fit a second passage 2P on the upright shaped wall of the body 2. Sideways, close to the median surface and in communication with the rear area 2C, the support 29 provides a grooved guide 29B adapted to house a pushrod 33 moving inside it both lengthwise and angularly for shorter excursions.

A membrane 28 resting peripherally on the membrane support 29 delimits a closed space containing a rectangular plate 30 with an interlaying cylindrical spring 32. Such a rectangular plate 30 has a prong 30A sideways, as shown in the FIGS. 4 and 5, which engages a cavity 33A of the pushrod 33. Therefore, such plate 30 comes to strike against the pushrod 33, adhering at the same time to a raised rectangular central portion of the membrane 28.

The rectangular plate 30 is hinged on one side of the membrane support 29, so as to rotate a few degrees and let the pushrod 33 move lengthwise to the body 2. An extendable guide 40 is located on the end of the pushrod 33, i.e. between it and the grooved guide 29B.

The shaped seat 2A is closed by the lid 8 fitted with the above inlet 7 in fluid connection with the membrane support 29 and consequently with the connector 31 through a small port 28A located below the membrane 28.

In the rear area 2C, in correspondence with the second passage 2P, a rotary arm globally indicated with reference 34 engages a rotating connection. Such rotary arm 34 consists of two half-shells 34A and 34B, the assembly thereof delimits inside the rotary arm 34, a duct implementing a fluid connection between the second passage 2P and a small shower 35. Such small shower 35 consists of an overhanging projection located at the end of the rotary arm 34, namely on the inner half-shell 34A; an outlet on its lower side is provided for the water to be sprayed, not represented for simplicity's sake.

The rotary arm 34 is adapted to pivot around a mouthpiece 34I on the lower side of the inner half-shell 34A. The mouthpiece 34I is cylindrically shaped and in fluid connection with the above inner duct to the rotary arm 34. In its assembled position, the mouthpiece 34I engages the second passage 2P, obtaining in such a manner a cylindrical hinge.

The rotary arm 34 is movable between the following positions:
start or reset position P1, represented in FIG. 4, where the small shower 35 is located in correspondence with the container 6A of the main compartment 6;
positions P2 and P3, corresponding e.g. to two pre-wash steps of a dishwashing machine incorporating the dispenser 1, in which the small shower 35 is respectively located above the first and second compartment of the first compartments 6′;
positions P4 and P5, corresponding e.g. to two further wash steps, in which the small shower 35 is respectively located above the first and second compartment of the second compartments 6″;
final or brigthener dispensing position P6, represented in FIG. 5.

As regards the rotary arm 34, its lengthwise axis follows the trend of a broken line forming an acute angle between its two branches, where the second branch is practically horizontal in its assembled condition and in position P1, forming an open V with the first one.

Moreover, the rotary arm 34 provides:
a ledge or catch 34C, located just below the second length substantially horizontal of the rotary arm 34, projecting inside the device 1.
a circular toothed sector 34D, near the fulcrum around which the rotary arm 34 pivots, on the hollow side between the above V lengths;
a strike plate 34E projecting inside the dispenser 1 in correspondence with the lower end of the circular sector featuring the toothed sector 34D.

The toothed sector 34D of the rotary arm 34 consists of 5 shaped teeth, which form an integral body together with the outer half-shell 34B and ledge 34C. Additionally, the ledge 34C is associated to a further toothed sector 36 integral to the door 3 projecting outside it inside the dispenser 1 on a peripheral wall 6P of the container 6A of the door 3, as clearly shown in FIGS. 3 and 5. This further toothed sector 36 has a plan form of a circumference arch with its centre in the fulcrum of said rotary arm 34 and a radius substantially equal to the distance between it and the ledge 34C.

On the contrary, the toothed sector 34D is associated to a sharp end 33B of the pushrod 33, as clearly illustrated in FIGS. 4 and 5, so as to have the sharp end 33B constantly under pressure on the toothed sector 34D. Such pressure is ensured by a second return spring 37 associated to said pushrod 33, which is connected on the other end to the main body 2, in order to obtain a pull force component developing in a radial direction with respect to the toothed sector 34D.

In its operating condition, the ledge 34C remains engaged to the further toothed sector 36 due to the action of a third return spring 38 associated on one side to the rotary arm 34 and on the other side to the main body 2, so that its action is mainly developed in a tangential direction with respect to the pivot movement of the rotary arm 34.

The strike plate 34E, on the contrary, is adapted to operate when the rotary arm 34 is in the final position P6 of FIG. 5, i.e. at stroke end in the brigthener dispensing step, pushed on the second end 21B of the dosing control lever 21 through the imposed contact with the inclined plane 21C of the end 21B.

Moreover, when the arm 34 in its assembled position inside the dispenser 1, the strike plate 34E engages a port 2L shaped as an annular sector, whose width equals the length extension of the strike plate 34E. The form of this port 2L delimits a stroke start position and a stroke end position for the arm 34 when the strike plate 34E is in contact with both ends of the annular sector forming the port 2L itself.

FIG. 3 shows a perspective inner view of the door 3 in a preferred embodiment as an integral piece made from appropriate thermosetting plastic material.

The guide 17 located below on the same side of the tank 5 containing the brigthener is illustrated in details with its circular dual ring housing the movable release button 16.

Also, the further toothed sector 36 consisting of four shaped teeth and notwithstanding all the components previously mentioned, are clearly illustrated.

Among the further compartments 6C it can be noticed, in particular, how the threshold of the side wall of the first two compartments 6′ communicates with the section 6B of the main compartment 6 at a higher level with respect to the threshold of the two second compartments 6″. Such configurations allow a direct water outflow straight in the machine through the ducts beneath the first compartments 6′, whereas the second compartments 6″ overflow in the section 6B and therefore in the container 6A ending in the wash tub.

FIG. 4 shows the rear view of the device 1 without the body cover 2D, in its position with the door 3 closed, no hydraulic operation and the rotary arm 34 in its initial or reset position P1, i.e. with the small shower 35 in position adapted to dispense the water in the container 6A of the main compartment 6.

In particular, the pushrod 33 provided with the cavity 33A on its end is clearly highlighted, wherein the prong 30A engages further sliding inside the grooved guide 29B of the membrane support 29. Such pushrod 33 is in a retracted position with its sharp end 33B kept uplifted from the toothed sector 34D, so the rotary arm 34 can pivot in both directions.

The first end 21A of the dosing control lever 21 is also shown, the final projecting U-shaped portion thereof engages on the shaft head of the brigthener dispensing device 23, as already known in the state of the art.

FIG. 5 shows the same view of FIG. 4 with the rotary arm 34 in the final position P6 during the liquid washing agent or brigthener dispensing step, with the hydraulic operation activated; this means that the pushrod 33 is in its extracted position, i.e. on the border of the grooved guide 29B of the membrane support 29, where it can slightly rotate being no longer locked by the extendable sheath 40. The sharp end 33B of the pushrod 33 strikes against the last tooth of the toothed sector 34D of the rotary arm 34.

FIG. 6 shows schematically a first side view 6A of an hydraulic system of a dishwashing machine, indicated with ML as a whole, incorporating the dispenser 1 and a second view 6B. Such view 6B is of a same type with regard to the one illustrated in 6A; it shows a dishwashing machine ML with a small implementation of the hydraulic system, as better detailed hereafter.

Several elements of the dishwashing machine ML are already known, so they are not detailed nor described herein for the sake of simplicity.

Both views 6A and 6B illustrate the dispenser 1 located on the front of an upper tray CS, that can be extracted from a wash tub VL of the dishwashing machine ML, directly facing an inner door CP of the dishwashing machine ML when the door of the machine itself is closed. The door 3 of the dispenser 1, in its closed position, faces the inner door CP enabling a front access to its compartments of washing agents and ensuring their easy refilling once the upper tray CS is in its extracted operative position. On its rear side, the main body 2 provides means known in the art but not represented for simplicity's sake, which are used to lock the dispenser 1 on metal wires forming the upper tray CS.

With reference to the view 6A, the hydraulic system of the dishwasher ML comprises a wash pump PL with water intake from a bottom pit P integrated in the wash tub VL. Downstream the pump PL a first takeoff D1 is in fluid connection with a first sprayer I1 near the tub bottom VL, a second takeoff D2 conveys the water to a second sprayer I2 below the upper tray CS. In particular, the second takeoff D2 conveys the water to a little dome CU located over a second sprayer I2 through a known mouthpiece device D, adapted to let the upper tray CS be movable and consequently removable from the tub VL. Besides a usual passage to the second sprayer I2, the above little dome CU has a third takeoff D3 in fluid connection with the inlet 7 of the dispenser 1.

FIG. 12 illustrates a top view of the portion of the hydraulic system of the washing machine ML going from the little dome CU of the upper sprayer I2 to the inlet 7 of the dispenser 1. As it can be noticed, the dispenser 1 is located at the right of the third takeoff D3, which continues as a natural straight extension of the second takeoff D2.

The hydraulic circuit of the implementation of the dishwasher ML represented in the view 6B, differs from the description and illustration of the view 6A as follows: the wash pump PL has a further takeoff DU downstream, which continues in parallel to the second takeoff D2 until it engages the mouthpiece device D continuing further to outflow in the inlet 7 of the dispenser 1. In its last length, this further takeoff (DU) identifies with the third takeoff D3 of the view 6A, continuing further over the small dome CU of the upper sprayer I2.

The operation of the hydraulic circuit is briefly explained as follows.

The wash water taken in from the bottom pit P is conveyed by the wash pump PL to the first sprayer I1 through the first takeoff D1, to the mouthpiece device D through both the second takeoff D2 and the possible further takeoff DU in the case of the circuit shown in the view 6B. Inside the mouthpiece device D the wash water coming from the further takeoff DU maintains a preferential path with respect to the second takeoff D2, the takeoff DU engaging the small dome CU. In the solution illustrated in the view 6A for a first hydraulic circuit, the wash water entering the small dome CU continues up to the dispenser 1 with a certain pressure loss; in the implementation shown in the view 6B it reaches the dispenser 1 through a preferential path, with a minor pressure drops.

Therefore, with an equivalent pressure downstream the wash pump PL, the above implementation 6B allows advantageously a minor pressure drop and consequently a more efficient spraying of the wash water in the user elements I1, I2, 1 of the hydraulic system of the washing machine ML. The independent development of the further takeoff DU with respect to the second takeoff D2 causes minor pressure drops inside the hydraulic circuit, as it can be also demonstrated experimentally.

As usually done at the present state of the art, the dishwashing machine ML provides a selector device for selecting the various operation programs connected with a monitoring circuit for the performance of the various steps of a complete wash cycle. From the previous description of the hydraulic circuit operation of the dishwasher ML, it is clear how as soon as the wash pump PL starts operating, it will implement hydraulic operation of the dispenser 1 besides supplying the sprayers I1 and I2. The wash water can enter the inlet 7 of the dispenser 1 with a pressure oscillating between 0,1 and 0,3 bar.

Now the operation of the washing agents dispenser 1 for washing machines ML, in particular for a dishwasher, will be described.

At an initial step F1 the dispenser 1 provides the door 3 open as shown in FIG. 1, the rotary arm 34 in the initial position P1 and no hydraulic actuation. Here the pushrod 33 is in its retracted position and the brigthener dispenser 23 in its closed position. Before selecting a wash program through the selector device and starting a wash cycle, the user of a dishwashing machine ML provides to fill the single compartments 6′, 6″ with a dose of washing agents or place a detergent tablet in the main compartment 6.

After having closed the door 3 and started the dishwasher, the usual operations such as wash water intake in the wash tub of the dishwasher ML are performed; in the meanwhile the monitoring circuit requests a dispensing step of washing agents or second step F2, such as a pre-wash step, and operation of the wash pump PL is started. Therefore the hydraulic actuation is activated.

In general, with the hydraulic actuation activated, the wash water enters the inlet 7 of the dispenser 1 under pressure and impacts the membrane 28 whereto it transfers the hydraulic pressure for the movement of the rectangular plate 30. As a result, the pushrod 33 starts moving and reaches its extracted operative position. The same wash water flows from the port 28A into the passage 29A, then through the connector 31 and second passage 2P inside the rotary arm 34 up to the small shower 35. Thus, the wash water is going to spray a compartment underneath 6, 6′, 6″, according to the operative position of the rotary arm 34.

Therefore, the machine operates according to the following steps.

In the initial step F1 the user loads the proper amount of washing agents in the compartments 6 and 6C, in the specific example a number of five including the main compartment 6 also adapted to contain a solid washing agent in the solid form or a tablet.

The rotary arm 34 is in a reset or initial position P1. The user manually closes the door 3, places the upper tray CS of the dishwashing machine ML totally inside the wash tub and closes the door. Then the wash program is started through the selector device. The wash pump PL is deactivated and the wash tub has no water.

After a programmed time from the start of the wash cycle, the monitoring circuit of the dishwasher ML implements the second step F2. The wash pump PL starts operation, activating hydraulic operation of the dispenser 1.

According to the procedures previously described, the pushrod 33 causes its sharp end 33B to impact first the first tooth of the toothed sector 34D, and then to operate or the same tooth for the rotary arm 34 to rotate up to the position P2. The pushrod 33 is now in its extracted operative position. Due to the previous closure of the door 3 in the initial step F1, the retainer or ledge 34C is in contact with the further toothed sector 36 on the door 3, exerting a light pressure on it. When the rotary arm 34 rotates from the position P1 to P2, the ledge 34C rises on the inclined plane of the first tooth of the further toothed sector 36 until it engages the subsequent throat. Thus, once the hydraulic operation step stops, the rotary arm 34 is locked in position P2 hindering a return to the position P1, which would be ensured by the action of the third return spring 38. At the same time the pushrod 33 translates inside the grooved guide 29B of the membrane support 29 until it reaches its retracted position due to the action of the second return spring 37, thus releasing the contact with the toothed sector 34D of the rotary arm 34.

Meanwhile the wash water starts flowing out of the small shower 35 in the main compartment 6 according to the above procedure and is going to spray the adjacent compartment of the first compartments 6′ during the final movement of the rotary arm 34. At first, it fills one of the compartments 6′, namely the one adjacent to the main compartment 6, starting to dissolve the dose of washing agent inside it. Thereafter it overflows in the main compartment 6, taking the dissolving washing agent along with it. Furthermore, a portion of the wash water overflows also in the subsequent compartment 6′, where it starts to dissolve the washing agent to be used in a subsequent hydraulic actuation of the next step F3. The wash water overflowing in the main compartment 6 causes the detergent tablet, eventually placed in it, to dissolve completely. Once the washing agent has been dissolved, the wash water can freely flow down to the hopper container 6A and fall into the wash tub, where it performs its chemical action on the kitchenware to be cleaned.

The subsequent steps F3, F4, F5 are performed following a procedure similar to the one previously described, with the rotary arm 34 reaching the positions P3, P4, P5 respectively, and dispensing the wash water in the relevant first and second compartments 6′ and 6″. Actuation of the rotary arm 34 is always performed by the pressure of the incoming water at the start of every step, causing operation of the pushrod 33 through the membrane 28, membrane support 29 and rectangular plate 30.

The step F6 or brigthener dispensing is performed alike the previous ones; however, the following peculiarity should be noticed: when the pushrod 33 operates on the last tooth of the toothed sector 34D causing rotation of the rotary arm 34, the strike plate 34E of the arm 34 impacts the inclined plane 21C of the dosing control lever 21, i.e. operating on the second end 21B of such a lever 21. This causes the first end 21A to rotate, returned by the first spring 23M, causing the inner pin of the dispensing device 23 to move, which actuates in a known manner the dispensing of a brightener dose. As soon as the hydraulic operation stops, the ledge 34C rests again on the fourth and last tooth of the further toothed sector 36, with the rotary arm 34 in the position P5. Only when the door 3 opens, the ledge 34C releases its engagement with the further toothed sector 36, and can rotate to the initial or reset position P1 under the action of the third spring 38, in order to start a new operation cycle.

The wash water contained in each compartment at the end of the hydraulic operation of each step F2-F5 flows out of the relevant first and second compartments 6′ and 6″ into the tub, through a small port 6L located below each compartment 6′, 6″.

It should be noticed how both the motion of the rotary arm 34 in the various subsequent positions P1-P5 and associated dispensing of the wash water in the compartments 6, 6C are driven directly by the wash pump PL alone, using no other resources of the dishwashing machine ML. As a result, when the wash program performs dispensing of two different doses of washing agents without interrupting the wash pump operation PL, such as to implement two subsequent pre-wash steps F2 and F3 or wash steps F4 and F5, the monitoring circuit of the dishwashing machine will necessarily request a “Stop and Go” operation of the wash pump PL. In this event, the wash pump PL is not powered for a few seconds, in order to stop the hydraulic actuation of the whole hydraulic circuit of the dishwashing machine ML and let the pushrod 33 of the dispenser 1 move to its retracted position disengaging from the relevant tooth of the toothed sector 34D. A subsequent power supply and activation of the wash pump PL will activate the hydraulic operation of the dispenser 1 and implement a transfer of the rotary arm 34 from position P(i) to position P(i+1) as above, with a consequent dispensing of the wash water in the compartments 6, 6C. From the above description it is clear that both the form and size of the various compartments 6, 6′, 6″ for the washing agents can be designed to contain predetermined amounts or calibrated doses of washing agents.

Moreover, the whole device for a diversified dispensing of the wash water circulating in a dishwashing machine ML is adapted to perform dispensing of a plurality of preset amounts of washing agents contained in the single compartments 6, 6′, 6″ also during one same step of the wash cycle. This simply occurs through the “Stop and Go” instruction transmitted by the monitoring circuit of the dishwasher ML to the wash pump PL, as described above.

An advantage of the dishwashing machine fitted with the above dispenser is represented by its versatility and adaptability to comply with most various wash programs. Dispensing of the washing agents in the single wash steps can be performed up to very fine levels, as well as dispensing several doses of agents during one same step.

Another but not least advantage is represented by the wash pump of the washing machine being used for controlling the dispensing operation and dispensing the washing agents contained in the dispenser, i.e. a resource necessarily included in the machine itself.

As a resulting further advantage, the dispenser can operate a diversified dispensing of the washing agents while ensuring a certain saving of the machine resources. In fact, the dispenser has no electro-actuator elements or analogous devices specifically dedicated for the dispensing function of the washing agents; the same applies for the hydraulic system of the washing machine containing such a dispenser, which has no solenoid valve or equivalent device whatever.

A further advantage of the dishwashing machine is represented by the location of the washing agents dispenser, which can be assembled both on a kitchenware tray and/or in the inner door of the machine, since there are no technical counter-indications to this effect. However, it can be placed anywhere in the wash tub, save for the tub bottom for logistic reasons.

From the above description the features of the washing machine with improved operation, comprising a washing agents dispenser with diversified dispensing operation, as well as the method for implementing it are clear, and also the resulting advantages are clear.

It is clear that many other changes and applications are possible for the man skilled in the art to the washing machine with improved operation, comprising a washing agents dispenser with a diversified dispensing operation, as well as the method for implementing said dispensing operation, without departing from the novelty principles contained in the innovative idea; and it is clear that in its practical operation of the invention, the form of the components may often differ from the ones described, and be replaced with technical equivalent elements.

By way of example, FIGS. 7 and 8 illustrate a particular solution that can be adopted for the compartments area 3A of the door 3 of the dispenser 1, i.e. with the further compartments 6C removable with respect to the door 3. In particular, these figures are highlighting a compartments body 41, which can be released and removed from the body of the door 3, fitted with restraining means 42 known in the art ensuring its fastening to said compartments body 41 in a removable way. FIG. 7 shows a shaped wing sideways the compartments body 41, being adapted to engage an appropriate eyelet on the peripheral wall 6P, said shaped wing and eyelet providing the restraining means 42. These restraining means 42 can be replaced by other elements known in the art, which can ensure from a side a safe locking of the compartments body 41 to the door 3 of the dispenser 1, and to the other part a easy disengagement of the body from the door 3. Therefore, such a compartments body 41 is adapted to be replaced by another compartments body 41 having a different division of its inner compartments, i.e. with different capacities for a fine dispensing of the washing agents amount into tub.

In particular, the compartments body 41 consists of 4 upright recesses 41A, 41B, 41C and 41D communicating to each other through small passages 41P located on their bottom, in correspondence with the lengthwise axis of the compartments body 41, as clearly shown in FIG. 8. The first recess 41A provides a further passage 41P to the container 6A of the main compartment 6 for any residual wash water still in one or more recesses 41A, 41B, 41C e 41D, to flow definitively in the main compartment 6 and from here into the tub of the dishwasher at the end of each hydraulic actuation of the dispenser 1.

In their partition wall facing the main compartment 41, these recesses 41A, 41B, 41C and 41D provide upper rectangular cavities 43 in correspondence with the lengthwise axis of the compartments body 41. The cavities 43 of the above recesses 41A, 41B, 41C and 41D have an equal width and height incrementing from the recess 41D to the first recess 41A, in order to facilitate and lead a wash water overflow in the subsequent recesses 6A, 41A-41C following the direction to the main container 6A, i.e. of the wash water flowing into the tub.

Therefore, the embodiment of FIGS. 7 and 8 provides advantageously an exact addressing of the wash water during the hydraulic actuation of the dispenser and the subsequent overflow, i.e. the water overflowing from a compartment in which it is straight sprayed during a determined step is addressed with enough precision to a subsequent compartment towards the container 6A of the main compartment 6. As a result, the washing of the compartments and subsequent dispensing of the washing agents contained in it will be improved, since the compartments are washed with a greater quantity of water.

Another advantage is a higher versatility of the dispenser, which can be adapted to dishwashing machines implementing several different types of operation programs or to various type of washing machines. The compartments body 41 can be actually changed and replaced by other compartments bodies 41 with a different inner partition of the containers 41A-D, specific for each machine or wash program.

A further implementation of the dispenser assembled in the washing machine according to the present invention is shown in FIG. 9, illustrating a different rotary arm 134 of such a dispenser 1. In this figure the numbering is incremented by 100 for the components homologous to the ones illustrated in the FIGS. 2, 4, 5.

The implementation 134 differs from the rotary arm 34 of FIGS. 2, 4, 5 for a change to the circular toothed sector 134D, which has now one tooth less, i.e. four teeth. This toothed sector 134D is associated to a further toothed sector 134S consisting of one tooth only on a small equalizer 45, which pivots with respect to the same fulcrum F around which the whole rotary arm 134 is pivoting. The rotary arm 134 has a projecting collar 134F in correspondence with its rotation axis, on which a cylindrical end 45E of the equalizer 45 engages in a rotating connection. A fourth spring 46 is hooked to a prong 45N projecting from the end 45E of the equalizer 45 and to a projecting stake 134P sideways the rotary arm 134. Moreover, in a distal location with respect to the arm 134 the toothed sector 34D has a strike plate 134E apt to position the equalizer 45 for the further toothed sector 134S and obtain a continuity with the circular toothed sector 134D.

The above implementation variation changes the operation of the dispenser 1 as follows.

With reference to the position P5, i.e. the one prior to position P6 of FIG. 5, in which water is supplied to the last of the second compartments 6″, the pushrod 33 is engaged on the fourth and last tooth of the circular toothed sector 134D. The subsequent hydraulic actuation starting the step 6 of brigthener dispensing causes the pushrod 33 to engage the tooth of the further toothed sector 134S and push on it. According to the implementation, a rotation of the equalizer 45 is determined, which is returned by the fourth spring 46 as long as the pushrod 33 always stops on the last tooth of the circular toothed sector 134D. Thus, the rotary arm 134 does not pivot and remains in the previous position P5. As a result, the small shower 35 will supply the wash water always to the same compartment 6″ aiding to the excellent washing of the compartments area 3A and subsequent improved dispensing of the washing agent contained in the compartments 6, 6′, 6″.

Therefore, the wash water is advantageously used also in the brigthener dispensing step F6 to dissolve the powder washing agents and remove possible rests from the compartments 6, 6′, 6″.

FIG. 10 illustrates a further embodiment of the dispenser included in the washing machine according to the present invention, represented in its whole with reference 1′. In particular, this figure represents a perspective view of the dispenser 1′ without the body cover 2D, with the rotary arm 134 of the implementation of the dispenser 1 shown in FIG. 9 further assembled. All the components homologous to the ones of FIG. 1 are indicated with an apex “′”.

The dispenser 1′ of the implementation of FIG. 10, differs from the dispenser 1 of FIG. 1 for the following features:
It provides two independent wash water inlets 7′, 50 to the dispenser 1′, with the first 7′ connected to the actuator device 9′, whereas the second 50 engages the inner duct of the rotary arm 134;
The shape of the membrane 28′ in close contact with the rectangular plate 30′ provides total seal for the wash water, i.e. it has no through port 28A whatever;
The dispenser 1′ has no connector 31;
The membrane support 29′ consists of a closed shell, i.e. it has no port 29A whatever.

FIG. 11 clearly shows the above elements of the actuator device 9′, i.e. the membrane 28′, membrane support 29′ and rectangular plate 30′. The inlet 7′ is entirely analogous to the inlet 7 of FIG. 1, i.e. in communication to the whole actuator device 9′.

According to this embodiment, the wash water enters the actuator device 9′ from the inlet 7′ and transmits its pressure to the rectangular plate 30′ by means of the interlaying membrane 28′. Thus, the wash water cannot flow any more over said membrane 28′ with the ensuing pressure drop occurring up to the small shower 35 of the dispenser 1.

The second inlet 50 of the dispenser 1′ is delimited as the extension of the collar 134F projecting from the mouthpiece 134I of the rotary arm 134, referring to FIG. 9.

As it can be noticed, the collar 134F puts the second inlet 50 in communication to the inner room of the rotary arm 134 delimited between the two half shells 134A and 134B, so as to let the wash water flow through from the inlet 50 to the shower 135 of the rotary arm 134.

FIG. 13 illustrates an implementation of the hydraulic circuit of the dishwashing machine ML. This implementation is needed when adopting the dispenser 1′ of FIGS. 10, 11. FIG. 13 shows a top view of the final portion of the hydraulic circuit of the dishwashing machine ML fitted with the dispenser 1′ of FIGS. 10, 11. The portion of interest of the hydraulic circuit is the one going from the second takeoff D2 to the dispenser 1′. The difference between the two systems is that the third takeoff D3 has a fourth takeoff D4 conveying the wash water to the second inlet 50 of the dispenser 1′. As a result, at the inlet 50 there is nearly the same pressure as at the first inlet 7 of the dispenser 1′.

Surely the pressure at the second inlet 50 of the dispenser 1′ is higher than the pressure that reaches the mouthpiece 34I of the rotary arm 34 of the dispenser 1 of FIG. 1, since the passage area for the wash water in the fourth takeoff D4 is surely and considerably greater than the port 28A to the membrane 28 of the actuator device 9 of the dispenser 1, with a minor pressure drop for the water.

Besides having no connector 31, the dispenser 1′ according to the implementation of FIGS. 10, 11 provides the advantage of overcoming possible problems of poor pressure for water delivery to the small shower 35 of the rotary arm 34, which may arise in the solution of FIG. 1. The various calcareous deposits in the critical passage points of the actuator device 9 clearly illustrated in FIG. 2, such as the port edges 28A of the membrane 28 of the actuator device 9, may actually cause a considerable pressure drop to the small shower 35 with time, with a consequent inadequate spraying of the compartments 6, 6′, 6″ underneath. A likely obstruction of the port 28A may even occur and no wash water flow through. This would finally hinder a dispensing of the powder and/or solid washing agents contained in the dispenser 1, and seriously jeopardize the operation of the whole washing machine ML. It should be remembered, in fact, that a lack of wash water in the small shower causes no spraying of the compartments 6, 6′, 6″ with the washing agents not being dissolved and not dispensed in the wash tub VL of the washing machine ML.

In conclusion, this solution warrants a better control of the effective pressure of the wash water to the small shower 135 and in general of the following dispensing of the powder and/or solid washing agents in wash tub. Therefore, a greater functionality of the dispenser 1′ is carried out.

Another undeniable advantage is the higher reliability of the above implementation with time, as it surely removes the risk of a poor or even non performance of the dispensing of the washing agents due to the ageing of the washing machine.

A further significant feature of the dispenser according to the present invention—following appropriate modifications—is its capacity of housing a special tablet, as disclosed in the Italian patent no. IT1293637 filed by the present Applicant, the description of which is considered as an integral part of the present application. Such a tablet has a peculiar configuration, according to which the user can place it in the compartments 6, 6C after opening the door 3 of the dispenser exerting a light pressure from the top downwards. According to this implementation, the edges of the compartments 6′, 6″ are sharp in order to favour a chipping of the tablet after introduction therein. In particular, such tablets have a plurality of portions (20A, 20B—FIG. 5 of the above prior patent) separated by septa (5A) as particularly described at the page 14 of the prior patent.

This last implementation surely provides practical advantages for the user of a washing machine, as it will be enough to introduce a preformed tablet instead of dosing the washing powder in the single compartments. These tablets can be advantageously preformed according to the specific wash programs for easier loading of the detergent agent.

1. A washing machine, in particular a dishwasher, comprising:
a washing agents dispenser comprising actuator means for dispensing washing agents inside a wash tub of said washing machine,
a wash pump for wash water circulation inside an hydraulic circuit of said machine,
wherein said actuator means are assembled in a direct fluid connection to said wash pump through interlaying both connection means pertaining to said hydraulic circuit of said washing machine and at least an inlet of said dispenser, so that dispensing of the washing agents of said dispenser is driven by said wash pump through the change of the delivery pressure generated by its operation.

2. A washing machine according to claim 1, wherein said dispenser is housed on a kitchenware tray of said washing machine.

3. A washing machine according to claim 2, wherein said dispenser is housed on an upper tray of said machine, in particular facing an inner door of said machine for a easy access to it.

4. A washing machine according to claim 1, wherein said dispenser comprises diversified dispensing means for a diversified dispensing of said washing agents in said wash tub.

5. A washing machine according to claim 1, wherein said actuator means of said dispenser comprise an actuator device in fluid connection to an inlet of said at least one inlet of said dispenser, for a hydraulic control implementation related to said actuator device.

6. A washing machine according to claim 5, wherein said dispenser comprises:
a main body
containing means for washing agents associated with said main body,
accessing means to said containing means for loading said washing agents in said containing means, said containing means comprising a plurality of compartments for containing calculated doses of washing agents,
said diversified dispensing means having a selective dispensing operation, i.e. actuating the dispensing in the tub of each one of said calculated doses of washing agents contained selectively in a single compartment of said plurality of compartments.

7. A washing machine according to claim 1, wherein said diversified dispensing means and/or said actuator means of said dispenser comprise an arm movable in said main body at least from an initial position to a final position, said arm comprising a small shower in fluid connection with at least some of said actuator means and/or diversified dispensing means of said dispenser for introducing the water inside each single compartment of said plurality of compartments.

8. A washing machine according to claim 7, wherein said arm of said dispenser comprises constraining means with said main body of said dispenser, being adapted to ensure a rotation inside said main body among a number of positions substantially equal to the number of compartments forming said plurality of compartments, and its subsequent locking in said positions.

9. A washing machine according to claim 8, wherein said arm of said dispenser comprises fluid connecting means between said small shower and a passage of said constraining means of said dispenser, said passage belonging to an upright shaped wall of said main body of said dispenser.

10. A washing machine according to claim 9, wherein said connecting means of said dispenser comprise a mouthpiece of said arm of said dispenser leading to an inner duct delimited in the assembly of a plurality of components of said arm, said inner duct being in fluid connection to said small shower and said passage of said dispenser through said mouthpiece.

11. A washing machine according to claim 5, wherein said actuator device of said dispenser is associated to said arm for a stepping forward of the same from an initial operative position to a final operative position.

12. A washing machine according to claim 11, wherein said actuator means and/or selective dispensing means of said dispenser comprise:
a pushrod associated to said actuator device and movable from a retracted operative position to a extracted operative position,
a first elastic means restrained to said main body of said dispenser and associated to said pushrod,
said actuator device comprising a first element, which is movable with respect to said main body for stepping forward said pushrod from said retracted operative position to said extracted operative position, said pushrod being associated to said arm during the transfer from said retracted operative position to said extracted operative position, so as to actuate its advancement from an initial position to a final position; said first elastic means permitting a return of said pushrod from its extracted operative position to its retracted operative position as soon as the requested hydraulic actuation has terminated.

13. A washing machine according to claim 12, wherein said arm of said dispenser comprises engaging means inside which an end of said pushrod of said dispenser is engaged when said pushrod goes from said retracted operative position to said extracted operative position.

14. A washing machine according to claim 13, wherein said engaging means of said dispenser comprise the teeth of a circular toothed sector.

15. A washing machine according to claim 14, wherein said engaging means of said dispenser comprise an equalizer hinged around said mouthpiece fitted with a further toothed sector forming a continuity with the circular toothed sector when said further toothed sector is in a disengaged position, i.e. when said pushrod is in said retracted operative position.

16. A washing machine according to claim 15, wherein said equalizer of said dispenser comprises a return mechanism to said disengaged position.

17. A washing machine according to claim 16, wherein said return mechanism of said equalizer comprises an elastic means located between a prong projecting from an end of said equalizer, and a stake projecting sideways said rotary arm.

18. A washing machine according to claim 17, wherein said return mechanism of said equalizer comprises a strike plate on one distal end with respect to said arm, said strike plate positioning said equalizer in such a way to have at least a tooth of said further toothed sector form a continuity with said circular toothed sector.

19. A washing machine according to claim 5, wherein said actuator device of said dispenser comprises ports in fluid connection with said inlet of said dispenser and said inner passage of said upright shaped wall of said main body of said dispenser, through interlaying connection means of said dispenser.

20. A washing machine according to claim 5, wherein said actuator device of said dispenser comprises a membrane support shaped like a chamber with a first port of said ports on its lower side in fluid connection with said connecting means of said dispenser, said support having a grooved guide being adapted to house a further end of said pushrod of said dispensers; a membrane resting peripherally on said support in fluid connection with said inlet of said dispenser, said membrane having on its lower side a second port of said ports and further delimiting a closed space wherein said first element and a second elastic means are comprised for transmitting to said pushrod the hydraulic pressure due to the wash water operating on said membrane, the action thereof being returned by said second elastic means.

21. A washing machine according to claim 18, wherein said actuator device of said dispenser comprises a closed membrane support shaped like a compartment and having a grooved guide adapted to house a further end of said pushrod of said dispenser, and comprising a membrane with an even surface resting peripherally on said support, which delimits a closed space in which said first element and a second elastic means are comprised, said membrane providing a second port of said ports on its lower side.

22. A washing machine according to claim 19, wherein said first element of said dispenser is movably hinged to said membrane support and has a prong sideways on the opposite side, being adapted to be engaged to a cavity of said further end of said pushrod of said dispenser; said first element striking on one side against said pushrod and on the other side aginst a rectangular central portion of said membrane, so the membrane has a direct fluid connection to said inlet of said actuator device of said dispenser.

23. A washing machine according to claim 6, wherein said accessing means to said containing means, of said dispenser comprise a door movably restrained to said main body from at least an open position for access to said containing means to a closed position.

24. A washing machine according to claim 23, characterized in said containing means of said dispenser are directly associated to said door of said dispenser.

25. A washing machine according to claim 24, wherein said containing means of said dispenser comprise a compartments body rigidly restrained to said door of said dispenser, said compartments body providing restraining means for a likely removal and replacement of said compartments body with another compartments body.

26. A washing machine according to claim 25, wherein said containing means of said dispenser comprise a main compartment with a hopper recess for dispensing water in said wash tub of said washing machine.

27. A washing machine according to claim 6, wherein said containing means of said dispenser comprise compartments, each one of them with cavities obtained on the upper edge of one of their walls, so that the water introduced in each one of said compartments will overflow in the next one following a path conveying the water towards the outer wall of a first compartment, and flowing out in said main compartment of said dispenser.

28. A washing machine according to claim 6, wherein said containing means of said dispenser comprise a tank for containing a liquid washing agent or brightener.

29. A washing machine according to claim 28, wherein said selective dispensing means and/or said actuator devices of said dispenser comprise a brightener-brightener dispenser device associated to said tank of said dispenser for a diversified dispensing of said brightener in said tub of said washing machine.

30. A washing machine according to claim 7, wherein said restraining means of said arm of said dispenser comprise:
a retainer associated to said arm, being adapted to interact with a further toothed sector of said actuator means and/or said diversified dispensing means of said dispenser,
third elastic means associated to said arm such in a manner to ensure a return movement of said arm when the hydraulic actuation is deactivated, so as to lock said retainer in said further toothed sector of said dispenser.

31. A washing machine according to claim 30, wherein said further toothed sector of said dispenser is associated to said door of said dispenser and so designed that when said door is in a closed position, said retainer presses on said further toothed sector and remains in contact with it during the rotary movement between the second and fifth positions of said arm of said dispenser.

32. A washing machine according to claim 5, wherein said at least one inlet of said dispenser comprises a first inlet in fluid connection to said actuator device of said dispenser and a second inlet in fluid connection to said small shower of said arm of said dispenser.

33. A washing machine according to claim 10, wherein said second inlet of said dispenser is connected to said mouthpiece of said arm of said dispenser.

34. A washing machine according to claim 1, wherein said hydraulic circuit of said washing machine comprises a first takeoff D1 of said wash pump in fluid connection with a first sprayer, and a second takeoff in fluid connection with a second sprayer located in an upper trays of said machine, said second takeoff conveying said water inside a small dome of said second sprayer through a mouthpiece device being adapted to warrant both the motion and extraction of said upper trays from the tub, said small dome comprising a third takeoff in fluid connection to said at lease one inlet of said dispenser, so that said wash water will wash said compartments of said dispenser and dispense the washing agents contained inside them.

35. A washing machine according to claim 32, wherein said hydraulic circuit of said washing machine comprises a further takeoff being engaged to said wash pump downstream and continuing to be engaged into said mouthpiece following a preferential duct up to the inside of said small dome and then being coincident with said third takeoff up to said at least one inlet of said dispenser.

36. A washing machine according to claim 32, wherein said third takeoff of said hydraulic system of said washing machine comprises a fourth takeoff in fluid connection to said second inlet of said dispenser.

37. A washing machine according to claim 6, wherein said containing means of washing agents are designed for receiving a solid detergent agent, in particular tablets consisting of a plurality of portions connected to each other by means of septa.

38. A dispenser for a dishwashing machine, comprising a main body associated to:
containing means of washing agents,
accessing means to said containing means for loading said washing agents in said containing means,
actuator means for dispensing said washing agents in a wash tub of a dishwashing machine incorporating said dispenser,
diversified dispensing means connected to said actuator means for a diversified dispensing of said washing agents in said tub of said dishwashing machine incorporating said dispenser,
wherein, said diversified dispensing means have a selective dispensing operation, i.e. being adapted to dispense at least a single
dose of said washing agent in the tub, namely a well determined amount contained in each single compartment of said plurality of compartments.

39. A dispenser according to claim 38, wherein said actuator means are hydraulic operating actuator means.

40. A dispenser according to claim 38 further comprising a main body containing means for washing agents associated with said main body,
accessing means to said containing means for loading said washing agents in said containing means, said containing means comprising a plurality of compartments for containing calculated doses of washing agents,
said diversified dispensing means having a selective dispensing operation, i.e. actuating the dispensing in the tub of each one of said calculated doses of washing agents contained selectively in a single compartment of said plurality of compartments.

41. A method for dispensing washing agents in a wash tub of a dishwasher, having a washing agents dispenser comprising actuator means for dispensing washing agents inside a wash tub of said washing machine,
a wash pump for wash water circulation inside an hydraulic circuit of said machine,
wherein said actuator means are assembled in a direct fluid connection to said wash pump through interlaying both connection means pertaining to said hydraulic circuit of said washing machine and at least an inlet of said dispenser, so that dispensing of the washing agents of said dispenser is driven by said wash pump through the change of the delivery pressure generated by its operation, wherein such an operation occurs through a simple start of said pump, properly controlled by a control circuit of said machine adapted to the control and implementation of the wash cycles of the same machine.

42. A method according to claim 41, further comprising actuating a “Stop and Go” drive of said wash pump, in order to ensure dispensing of a subsequent dose of said washing agents during operation of the machine, providing a continuous supply of said wash pump.

43. A method according to claim 42, wherein said “Stop and Go” drive is active for about a few seconds.
